(19) United States
(12) Patent Application Publication
(10) Pub. No.: US 2025/0141970 A1
(43) Pub. Date: May 1, 2025

(54) PLATFORM-AS-A-SERVICE DEPLOYMENT INCLUDING SERVICE DOMAINS

(71) Applicant: Nutanix, Inc., San Jose, CA (US)

(72) Inventors: Akhilesh Joshi, San Jose, CA (US); Amit Jain, San Jose, CA (US); Sanika Mokashi, San Jose, CA (US); Bryan Crowe, San Jose, CA (US); Satyam Vaghani, San Jose, CA (US)

(73) Assignee: Nutanix, Inc., San Jose, CA (US)

(21) Appl. No.: 18/930,885

(22) Filed: Oct. 29, 2024

Related U.S. Application Data
(63) Continuation of application No. 16/945,306, filed on Jul. 31, 2020, now Pat. No. 12,155,731.
(60) Provisional application No. 62/913,115, filed on Oct. 9, 2019.

(51) Int. Cl. H04L 67/00; G06F 9/455; G06F 18/214; G06N 20/00; H04L 67/10; H04L 67/51

(52) U.S. Cl. CPC H04L 67/34; G06F 9/45558; G06F 18/214; G06N 20/00; H04L 67/10; H04L 67/51; G06F 2009/45562; G06F 2009/45595

(57) ABSTRACT

A platform-as-a-service (PaaS) manager abstracts deployment of PaaS software stacks to different computing platforms such that the PaaS software stacks provide a common platform to host an application despite differences in the underlying architectures of the computing platforms. Each PaaS software stack is hosted on a service domain installed on a respective one of the computing platforms, and includes an operating system and provides access to a set of services for execution of applications. The some examples, the different computing platforms include multiple different cloud architectures.

### CROSS REFERENCE TO RELATED APPLICATION(S)

This application is a continuation of U.S. application Ser. No. 16/945,306, filed Jul. 31, 2020, which claims priority to U.S. Provisional Application No. 62/913,115, filed Oct. 9, 2019, which are incorporated here in by reference, in their entirety, for any purpose.

### BACKGROUND

Public and private cloud service platforms can have varying architectures, including differing sets of host operating systems or hypervisors, differing sets of offered services, differing platform-specific application programming interfaces (APIs), different data storage structures, etc. As such, a customer that has operations on multiple cloud service platforms may need to independently develop a different version of an application to accommodate the differences between cloud platform architectures. The process of developing multiple versions of the same application to make it compatible with each desired cloud service platform can be technically complicated and time consuming, as it requires gathering an understanding the architecture of each target cloud service platform, and then developing a version of the application based on the architecture. Such an undertaking may beyond the scope or expertise of many information technology (IT) departments.

### BRIEF DESCRIPTION OF THE DRAWINGS

FIG. 1 is a block diagram of a multi-cloud platform as a service system, in accordance with an embodiment of the present disclosure.

FIG. 2 is a block diagram of a Service Domain, in accordance with an embodiment of the present disclosure.

FIG. 3 is a block diagram of components of a computing node in accordance with an embodiment of the present disclosure.

FIG. 4 is a flow diagram of a method to create an application for deployment to a computing platform, in accordance with an embodiment of the present disclosure.

FIGS. 5A-5K are depictions of exemplary user interface screenshots for deploying a service domain, in accordance with an embodiment of the present disclosure.

FIGS. 6A-6L are depictions of exemplary user interface screenshots for generating and deploying a data pipeline to one or more service domains, in accordance with an embodiment of the present disclosure.

FIGS. 7A-7E are depictions of exemplary user interface screenshots for generating and deploying a container to one or more service domains, in accordance with an embodiment of the present disclosure.

FIG. 8 is a depiction of an exemplary user interface screenshot for selecting a type of application to be deployed to one or more service domains, in accordance with an embodiment of the present disclosure.

FIGS. 9A-9B are depictions of exemplary user interface screenshots for generating and deploying an application to one or more service domains, in accordance with an embodiment of the present disclosure.

### DETAILED DESCRIPTION

Examples described herein include a platform-as-a-service PaaS infrastructure and application lifecycle manager (PaaS manager) configured to create and deploy service domains on one or more different types of computing platforms. The PaaS manager is also configured to build and deploy different types of applications to the service domains. An application may include a data pipeline, a container, a data service, a machine learning (ML) model, etc., or any combination thereof. A user may elect to deploy an application to a type of platform based on various criteria, such as type of service, proximity to source data, available computing resources (e.g., both type and available capacity), platform cost, etc., or any combination thereof. Types of platforms may include a cloud platform (e.g., Nutanix®, Amazon® Web Services (AWS®), Google® Cloud Platform, Microsoft® Azure®, etc.), a computing node cluster, a bare metal platform (e.g., platform where software is installed directly on the hardware, rather than being hosted in an operating system), an IoT platform (e.g., edge systems, etc.).

Generally, when an application is generated, successful execution may depend on availability of various additional supporting services, such as a read/write data services (e.g., publish/subscribe service, search services, etc.), data pipeline services, ML inference services, container management services, other runtime or data services, etc., or any combination thereof. The PaaS manager may abstract deployment of the additional supporting services, as some services may be platform-specific, as well as may manage a lifecycle of the service containers, upgrades and/or patches to the services, etc. Thus, a user may provide information directed to an application to be deployed to the PaaS manager and identify one or more target service domains, and the PaaS manager may deploy respective application bundle for each of the one or more target service domains that includes the application and/or the additional supporting services. In some examples, the supporting services may already be hosted on the service domain, which may preclude the necessity of including those services in the application bundle. The PaaS manager may deploy the respective application bundle to the corresponding one of the one or more identified target service domains. The ability of the PaaS manager to abstract platform-specific details for creating and deploying a service domain and deploying an application bundle to run in a service domain may make deployment of applications to different service domains and across different computing platforms more efficient for a user. This may allow a customer to operate in a hybrid of various different computing platform types in a way that differences between the various computing platform types is transparent to an end customer. The ability to deploy applications across different computing platforms may allow for more flexible multi-cloud and/or multi-platform data integration for a customer. The PaaS manager may be hosted in a cloud computing system (e.g., public or private) and/or may be delivered/distributed using a software as a service (SaaS) model, in some examples.

Various embodiments of the present disclosure will be explained below in detail with reference to the accompanying drawings. The detailed description includes sufficient detail to enable those skilled in the art to practice the embodiments of the disclosure. Other embodiments may be utilized, and structural, logical and electrical changes may be made without departing from the scope of the present disclosure. The various embodiments disclosed herein are not necessary mutually exclusive, as some disclosed embodiments can be combined with one or more other disclosed embodiments to form new embodiments.

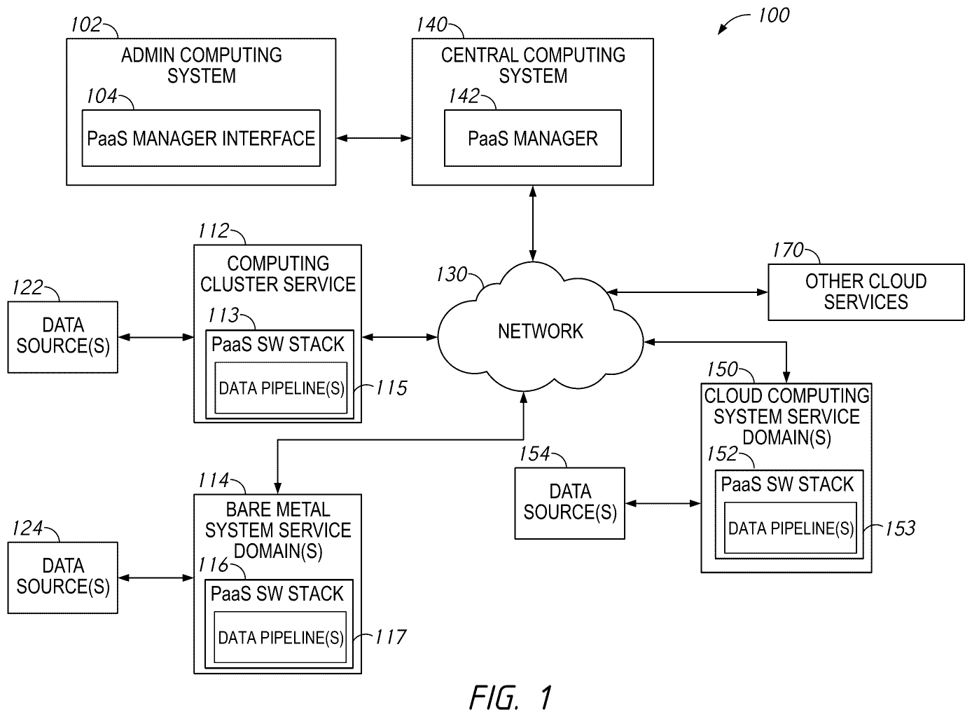

FIG. 1 is a block diagram of a multi-cloud platform as a service system 100, in accordance with an embodiment of the present disclosure. The system 100 may include one or more of any of computing cluster service domain(s) 112 coupled to respective data source(s) 122, bare metal system service domain(s) 114 coupled to respective data source(s) 124, and the cloud computing system service domain(s) 150 coupled to respective data source(s) 154. The system 100 may further include a central computing system 140 coupled to the one or more of the computing cluster service domain(s) 112, the bare metal system service domain(s) 114, and/or the cloud computing system service domain(s) 150 via a network 130 to manage communication within the system 100.

The network 130 may include any type of network capable of routing data transmissions from one network device (e.g., of the computing cluster service domain(s) 112, the bare metal system service domain(s) 114, the central computing system 140, and/or the cloud computing system service domain(s) 150) to another. For example, the network 130 may include a local area network (LAN), wide area network (WAN), intranet, or a combination thereof. The network 130 may include a wired network, a wireless network, or a combination thereof.

Each of the computing cluster service domain(s) 112 may be hosted on a respective computing cluster platform having multiple computing nodes (e.g., each with one or more processor units, volatile and/or non-volatile memory, communication or networking hardware, input/output devices, or any combination thereof) and may be configured to host a respective PaaS software stack 113. Each of the bare metal system service domain(s) 114 may be hosted on a respective bare metal computing platform (e.g., each with one or more processor units, volatile and/or non-volatile memory, communication or networking hardware, input/output devices, or any combination thereof) and may be configured to host a respective PaaS software stack 116. Each of the cloud computing system service domain(s) 150 may be hosted on a respective public or private cloud computing platform (e.g., each including one or more data centers with a plurality of computing nodes or servers having processor units, volatile and/or non-volatile memory, communication or networking hardware, input/output devices, or any combination thereof) and may be configured to host a respective PaaS software stack 152. “Computing platform” referred to herein may include any one or more of a computing cluster platform, a bare metal system platform, or a cloud computing platform. “Service domain” used herein may refer to any of the computing cluster service domain(s) 112, the bare metal system service domain(s) 114, or the cloud computing system service domain(s) 150. The PaaS software stacks (e.g., any of the PaaS software stack, the PaaS software stack PaaS software stack 113, PaaS software stack 116, and/or PaaS software stack 152) may include platform-specific software configured to operate on the respective system. The software may include instructions that are stored on a computer readable medium (e.g., memory, disks, etc.) that are executable by one or more processor units (e.g., central processor units (CPUs), graphic processor units (GPUs), tensor processing units (TPUs), hardware accelerators, video processing units (VPUs), etc.) to perform functions, methods, etc., described herein.

The data source(s) 122, 124, and 154 may each include one or more devices or repositories configured to receive, store, provide, generate, etc., respective source data. The data sources may include input/output devices (e.g., sensors (e.g., electrical, temperature, matter flow, movement, position, biometric data, or any other type of sensor), cameras, transducers, any type of RF receiver, or any other type of device configured to receive and/or generate source data), enterprise or custom databases, a data lake (e.g., a large capacity data storage system that holds raw data) or any other source of data consumed, retrieved, stored, or generated by the service domains. The service domain construct may allow a customer to deploy applications to locations proximate relevant data, in some examples. In some examples, the service domain construct may allow a customer to deploy applications to computing platforms that have a particular computing resource (e.g., hardware or software configuration) and/or based on computing resource capacity.

In some examples, various components of the system 100 may need access to other cloud services 170. To facilitate communication with the other cloud services 170, the data pipelines of the PaaS software stacks may be configured to provide interfaces between applications hosted on one or more of the service domains 112, 114, or 150 and the other cloud services 170 via the network 130. In some examples, the data pipeline(s) 115, 117, and/or 153 (data pipeline(s)) hosted on any of the PaaS software stacks 113, 116, and/or 152, respectively, may be configured to provide data from the other cloud services 170 to applications hosted on one or more of the service domains 112, 114, or 150 to aggregate, transform, store, analyze, etc., the data.

Each of the PaaS software stacks may include one or more applications, data pipelines, ML models, containers, data services, etc., or any combination thereof (e.g., applications). The applications may be configured to receive, process/transform, and output data from and to other applications. The applications may be configured to process respective received data based on respective algorithms or functions to provide transformed data. At least some of the applications may be dependent on availability of supporting services to execute, such as communication services, runtime services, read-write data services, ML inference services, container management services, etc., or any combination thereof.

The data pipeline(s) 115, 117, and/or 153 may provide a conduit through which data can be passed (e.g., provided and/or received) between applications hosted in the PaaS Software stack, as well as a conduit through which data can be passed among the different service domains or to the other cloud services 170 via the network 130. Generally, a data pipeline of the data pipeline(s) 115, 117, and/or 153 may include an input component to receive data from another data pipeline, any data source, or other service domain or cloud service 170 (via the network 130); an output component to provide data to another data pipeline, any data source, or other service domain or cloud service 170 (via the network 130); and at least one transform component configured to manipulate the input data to provide the output data.

The data pipeline(s) 115, 117, and/or 153 can be constructed using computing primitives and building blocks, such as VMs, containers, processes, or any combination thereof. In some examples, the data pipeline(s) 115, 117, and/or 153 may be constructed using a group of containers (e.g., a pod) that each perform various functions within the data pipeline (e.g., subscriber, data processor, publisher, connectors that transform data for consumption by another container within the application or pod, etc.) to consume, transform, and produce messages or data. In some examples, the definition of stages of a constructed data pipeline application may be described using a user interface or REST API, with data ingestion and movement handled by connector components built into the data pipeline. Thus, data may be passed between containers of a data pipeline using API calls.

In some examples, the PaaS software stacks may further include respective ML inference services that are configured to load and execute respective ML model applications. Thus, the ML inference services may be configured to receive a request for an inference or prediction using a ML model, and to load a ML model application that includes the requested ML model into an inference engine. The inference engine may be configured to select a runtime based on a hardware configuration of the edge system, and execute the ML model on input data to provide inference or prediction data. The inference engine may be configured to optimize the ML model for execution based on a hardware configuration. The ML inference service may provide the benefits of GPU abstraction, built-in frameworks for ML model execution, decoupling application development from hardware deployment, etc. In some examples, the PaaS manager 142 may be configured to access data from one or more data lakes (e.g., via the data sources 122, 124, 154), transform the data from the one or more data lakes, train a ML model using the transformed data, and generate an ML model application based on the trained ML model.

The one or more applications of the PaaS software stacks may be implemented using a containerized architecture that is managed via a container orchestrator. The container orchestration managed by a PaaS infrastructure and application lifecycle manager (PaaS manager) 142 under the service domain construct may handle (e.g., using middleware) underlying details of the PaaS related to containerized management complexity, orchestration, security, and isolation, thereby make it easier for a customer or user to focus on managing the applications. The management may be scalable via categories. In some examples, the service domains may be configured to support multi-tenant implementations, such that data is kept securely isolated between tenants. The applications communicate using application programming interface (API) calls, in some examples. In some examples, the supporting services may also be implemented in the containerized architecture.

The PaaS manager 142 hosted on the central computing system 140 may be configured to centrally manage the PaaS infrastructure (e.g., including the service domains) and manage lifecycles of deployed applications. The central computing system 140 may include one or more computing nodes configured to host the PaaS manager 142. The central computing system 140 may include a cloud computing system and the PaaS manager 142 may be hosted in the cloud computing system and/or may be delivered/distributed using a software as a service (SaaS) model, in some examples. In some examples, the PaaS manager 142 may be distributed across a cluster of computing nodes of the central computing system 140.

In some examples, an administrative computing system 102 may be configured to host a PaaS manager interface 104. The PaaS manager interface 104 may be configured to facilitate user or customer communication with the PaaS manager 142 to control operation of the PaaS manager 142. The PaaS manager interface 104 may include a graphical user interface (GUI), APIs, command line tools, etc., that are each configured to facilitate interaction between a user and the PaaS manager 142. The PaaS manager interface 104 may provide an interface that allows a user to develop template applications for deployment of the service domains, identify on which service domains to deploy applications, move applications from one service domain to another, remove an application from a service domain, update an application, service domain, or PaaS software stack (e.g., add or remove available services, update deployed services, etc.).

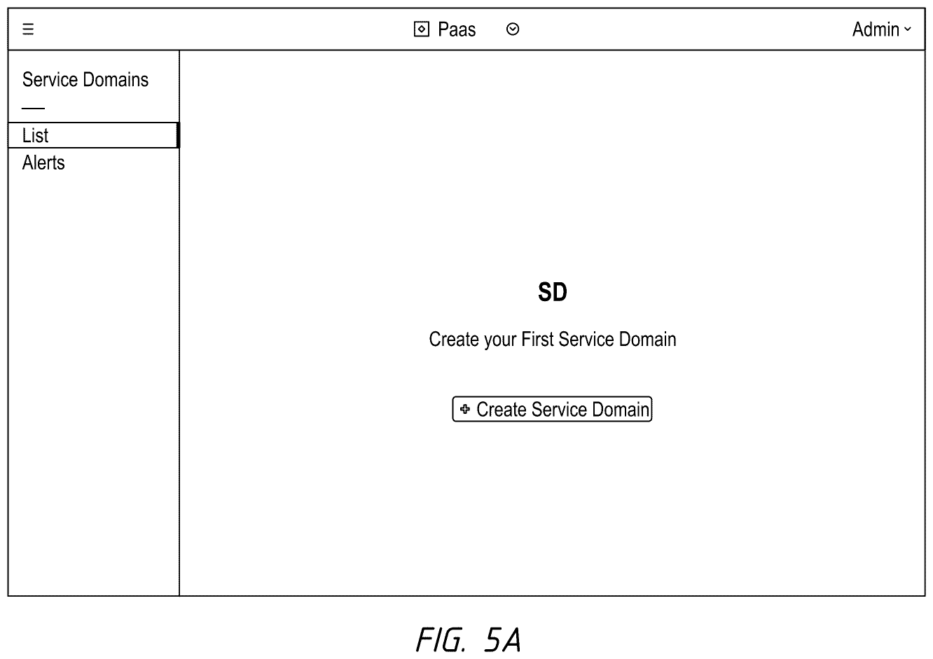

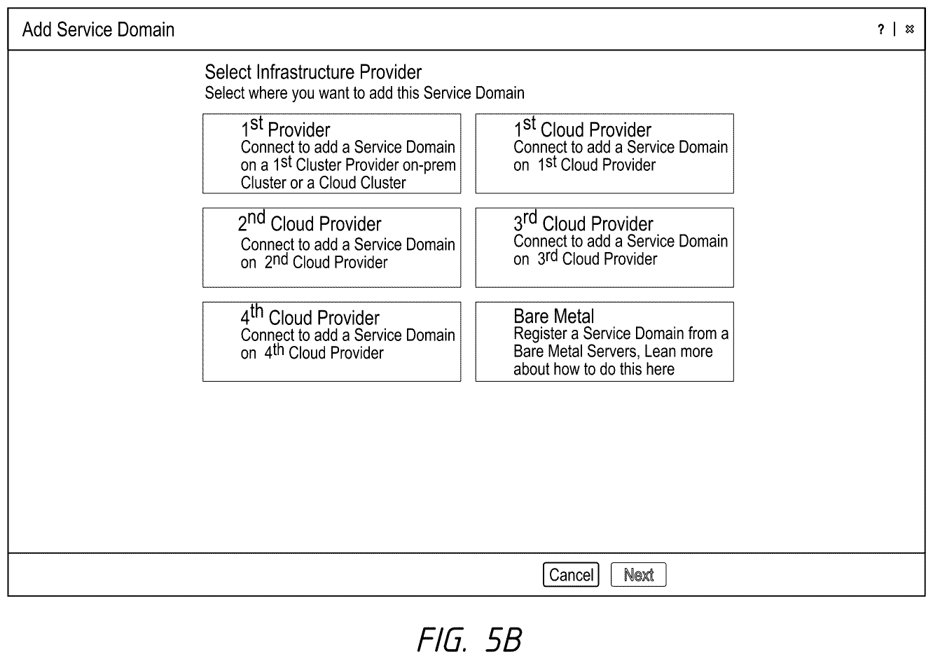

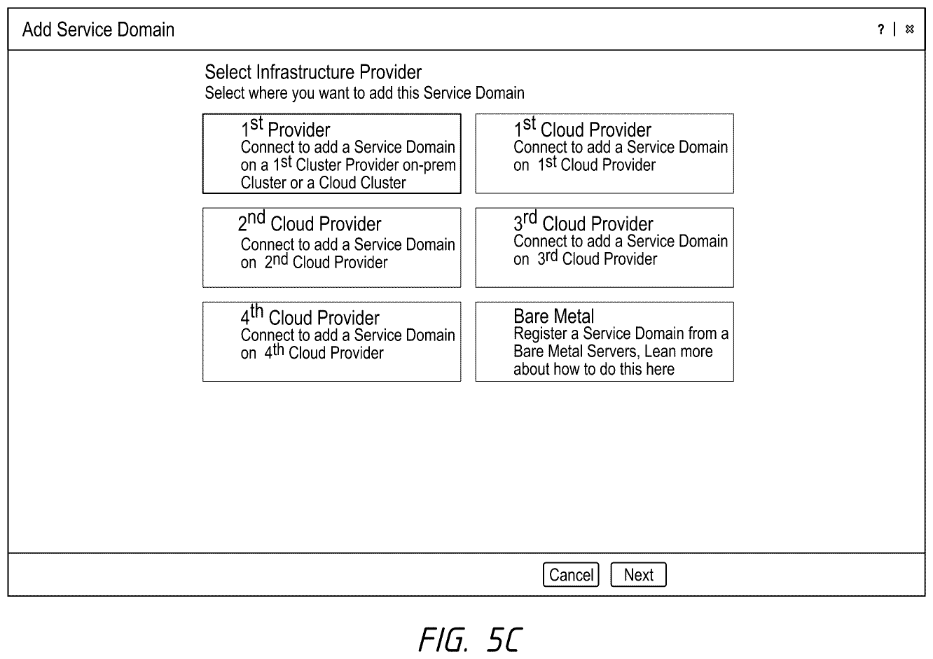

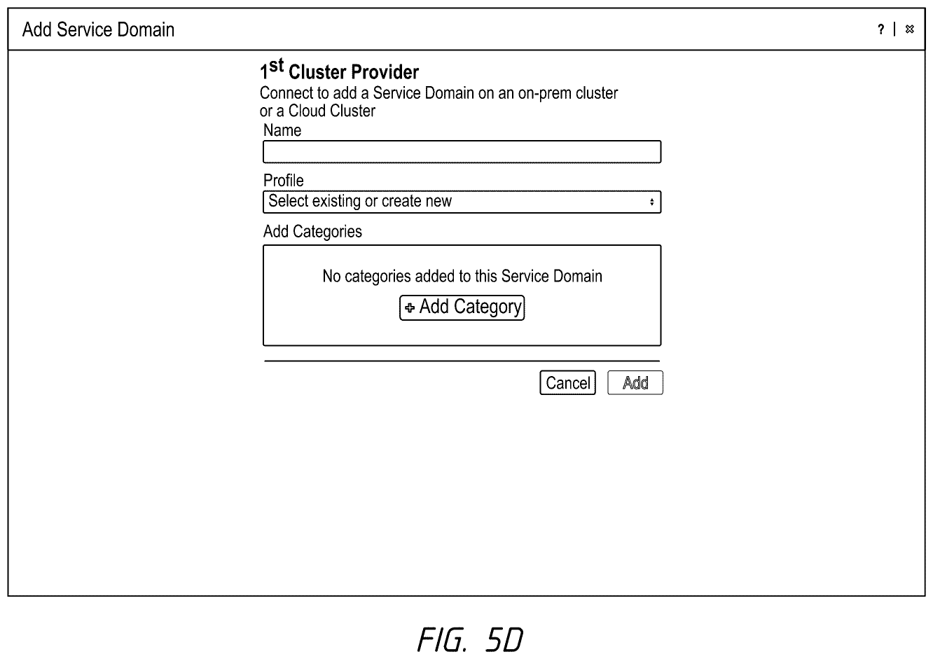

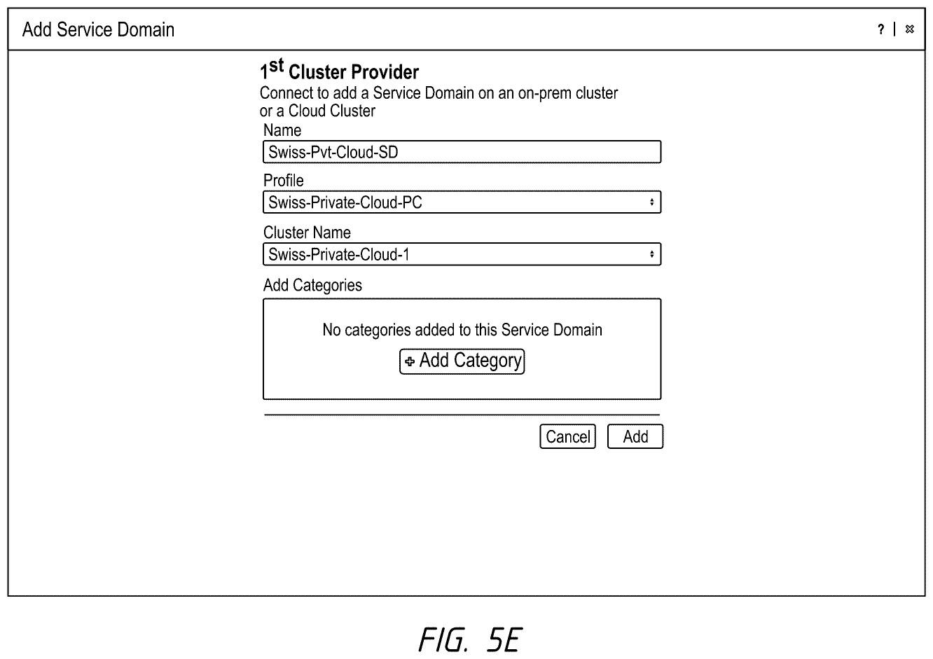

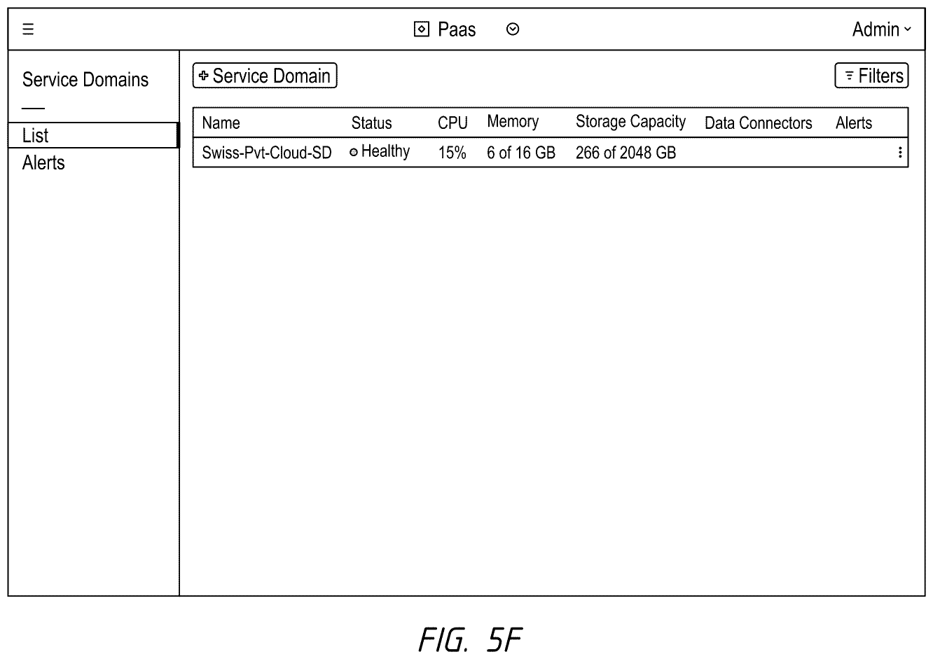

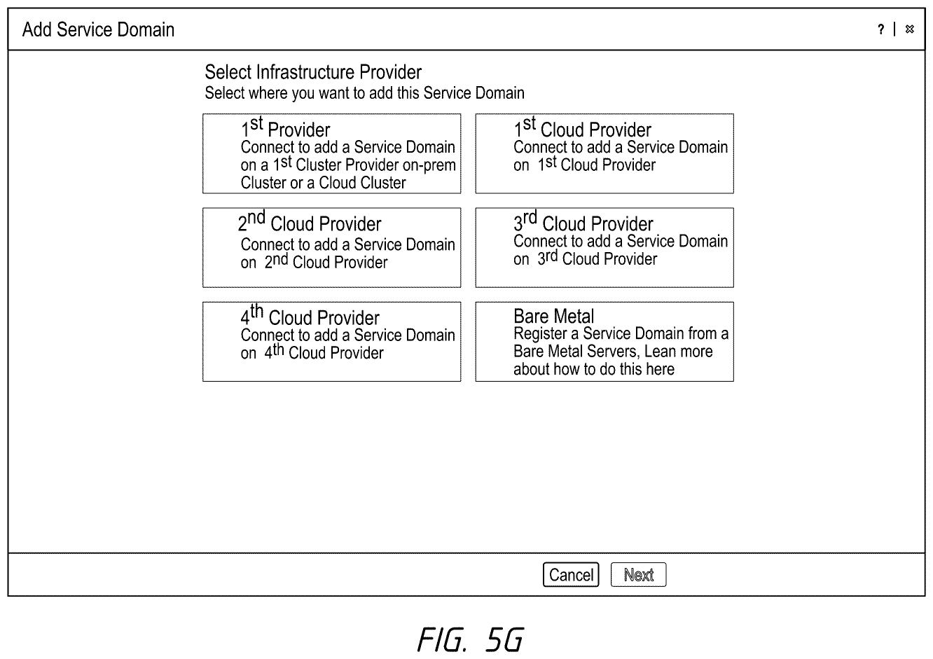

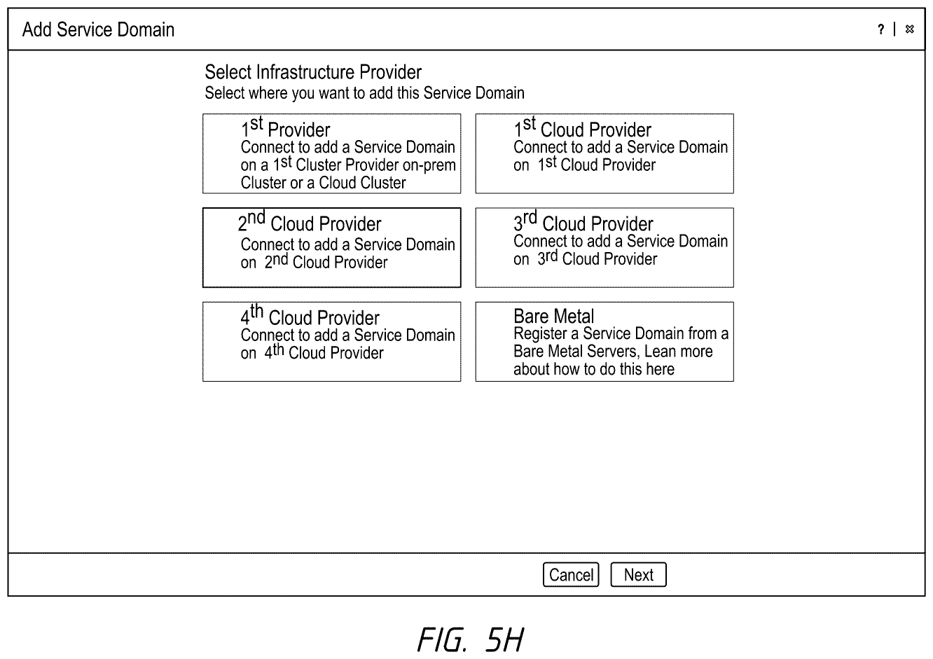

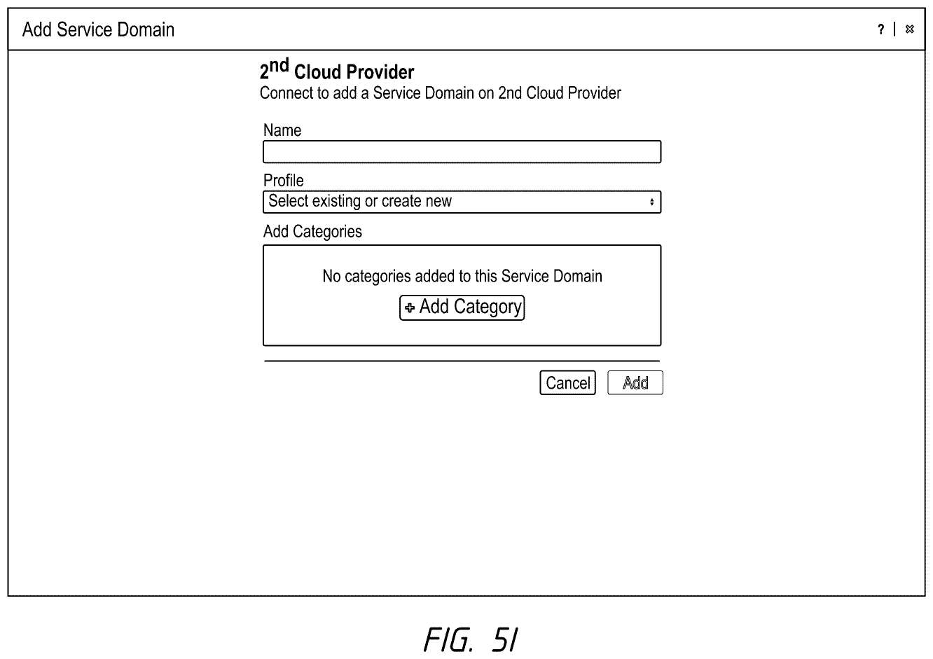

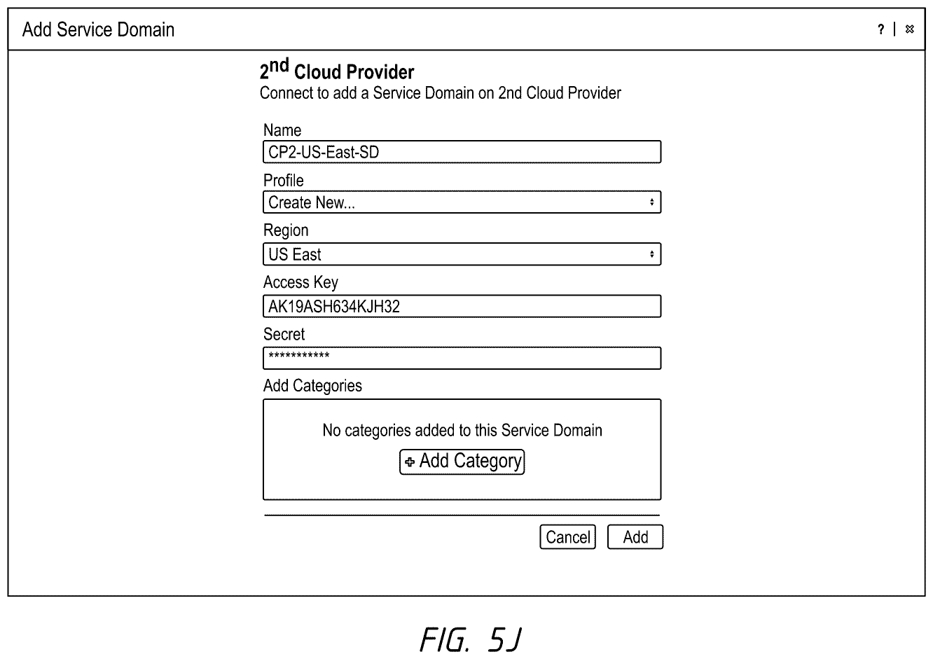

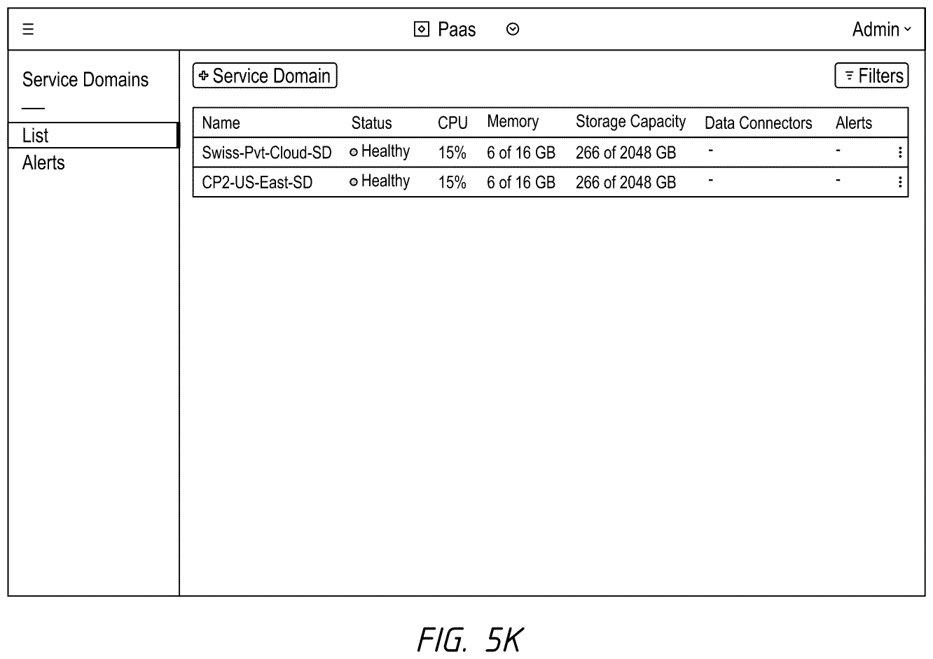

In some examples, the PaaS manager 142 may be configured to manage, for each of the computing platforms, creation and deployment of service domains, creation and deployment of application bundles to the PaaS software stacks, etc. For example, the PaaS manager 142 may be configured to create and deploy service domains on one or more of the computing platforms. The computing platforms may include different hardware and software architectures that may be leveraged to create and deploy a service domain. Thus, the PaaS manager 142 may be configured to manage detailed steps associated with generating a service domain in response to a received request. FIGS. 5A-5K are depictions of exemplary user interface screens for creating and deploying a service domain, in accordance with an embodiment of the present disclosure. The interfaces depicted in FIGS. 5A-5K may be implemented in the GUI of the PaaS manager interface 104. As shown in FIGS. 5A-5K, a user may step through various user interface pages to create and deploy a service domain by selecting various options, such as a computing platform (e.g., infrastructure provider) (FIGS. 5B, 5C, 5G, and 5H), selecting a name for the service domain (FIG. 5D, 5E, 5I and 5J). A list of available or generated service domains (e.g., FIGS. 5F and 5K) may be provided in the interface.

The PaaS manager 142 may also be configured to build and deploy different types of applications to one or more of the service domains. A user may elect to deploy an application to a type of platform based on various criteria, such as type of and/or availability of a service, proximity to source data, available computing resources (e.g., both type and available capacity), platform cost, etc., physical location of the platform, or any combination thereof.

When an application is generated, successful execution may depend on availability of various additional supporting services, such as a read/write data services (e.g., publish/subscribe service, search services, etc.), ML inference services, container management services, runtime services, etc., or any combination thereof. The PaaS manager 142 may abstract deployment of the additional supporting services, as some of these may be platform-specific. Thus, a user may provide information directed to an application to be deployed to the PaaS manager 142 and identify one or more target service domains, and the PaaS manager 142 may deploy the application to the target service domains. The target service domains provide services to be used by the application, and accordingly, the application need not include services provided by the service domain. Moreover, the application need not take platform-specific actions which may be typically required for starting those services. The PaaS manager 142 may deploy the respective application to the corresponding one of the one or more identified target service domains.

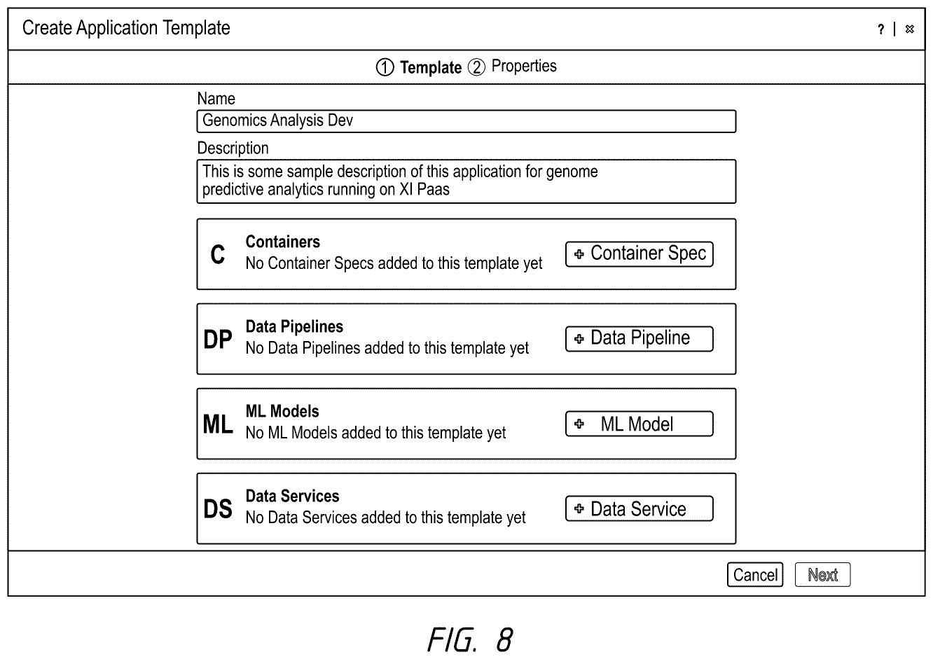

The ability of the PaaS manager 142 to abstract platform-specific details for creating and deploying a service domain and creating and deploying an application or application bundle to run in a service domain may make deployment of applications to different service domains more efficient for a user, as well as may provide a customer with a wider selections of platforms than would otherwise be considered. Thus, the service domain construct may allow a customer to focus on core concerns with an application, while shifting consideration of supporting services to the PaaS manager 142 and the service domains. The service domain construct may also make applications more “light weight” and modular for more efficient deployment to different service domains. The PaaS manager interface 104 may provide a GUI interface that FIG. 8 is a depiction of an exemplary user interface screenshot for selecting a type of application to be deployed to one or more service domains, in accordance with an embodiment of the present disclosure. The interface depicted in FIG. 8 may be implemented in the GUI of the PaaS manager interface 104. As shown in FIG. 8, a developer to create an application using a template. The template may include template processes for utilizing various services that may be provided by a service domain. As shown in FIG. 8, the service domain may provide container services, data pipelines, ML models, and/or data services. To develop an application utilizing such a service, the developer may select and define the services to be used through the template provided in the GUI of the PaaS manager interface 104.

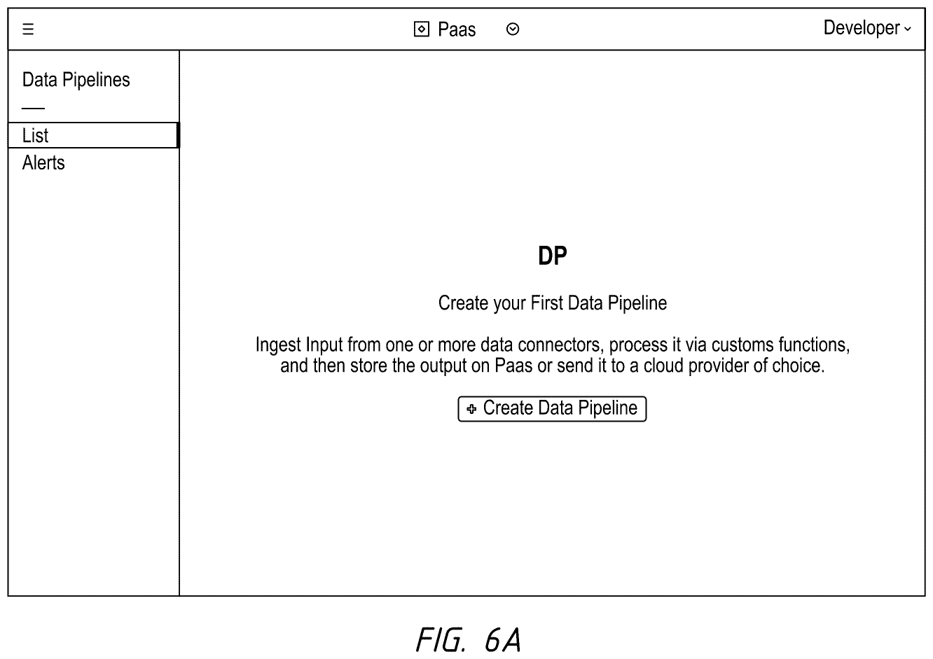

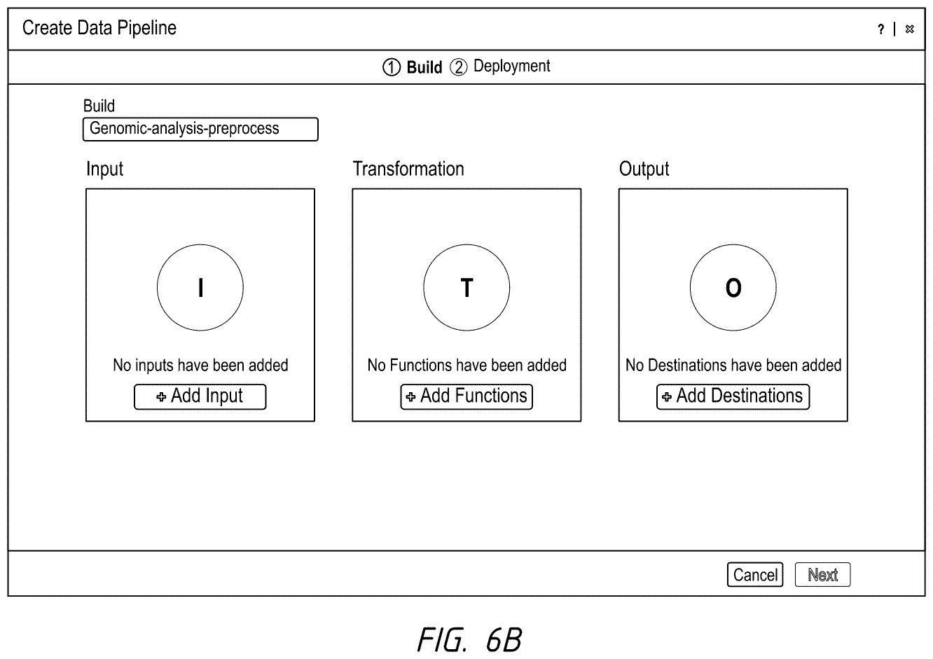

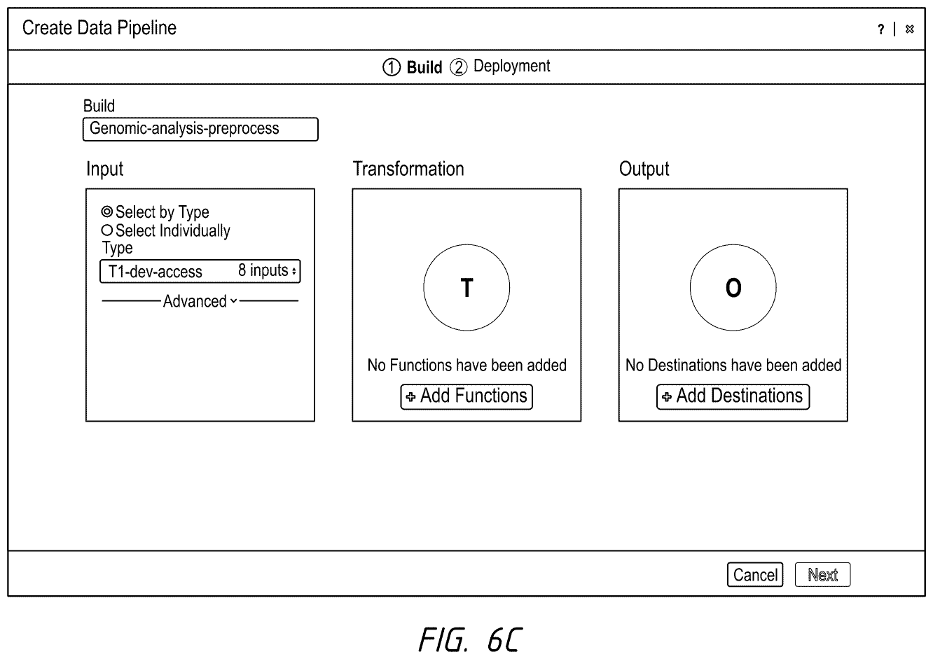

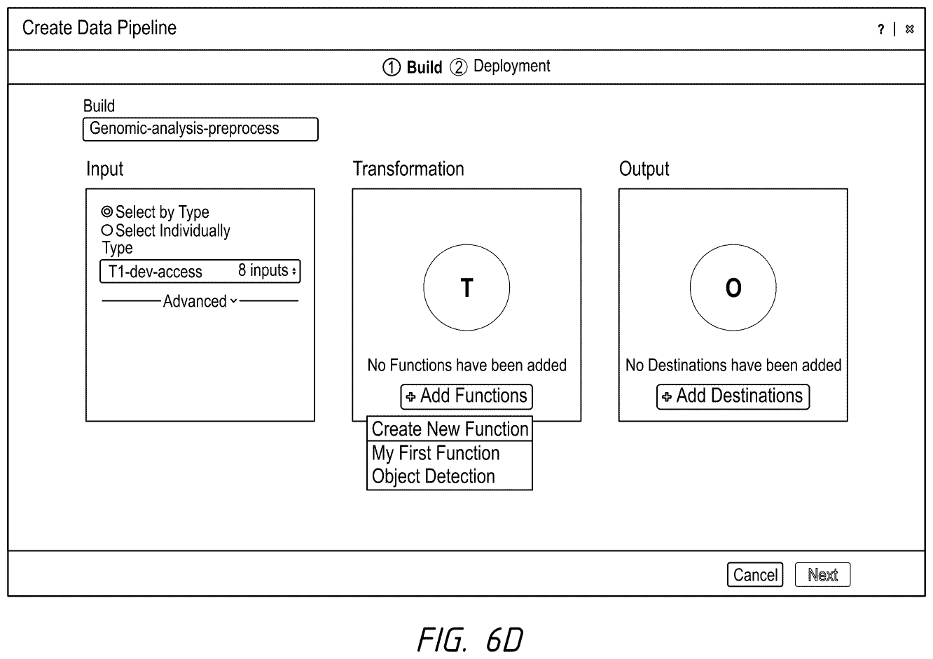

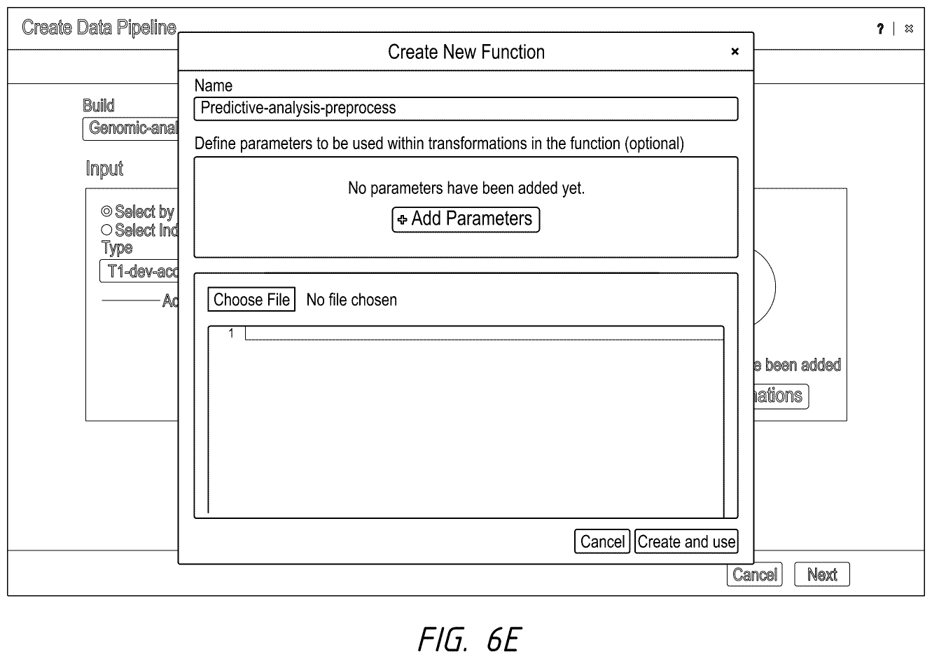

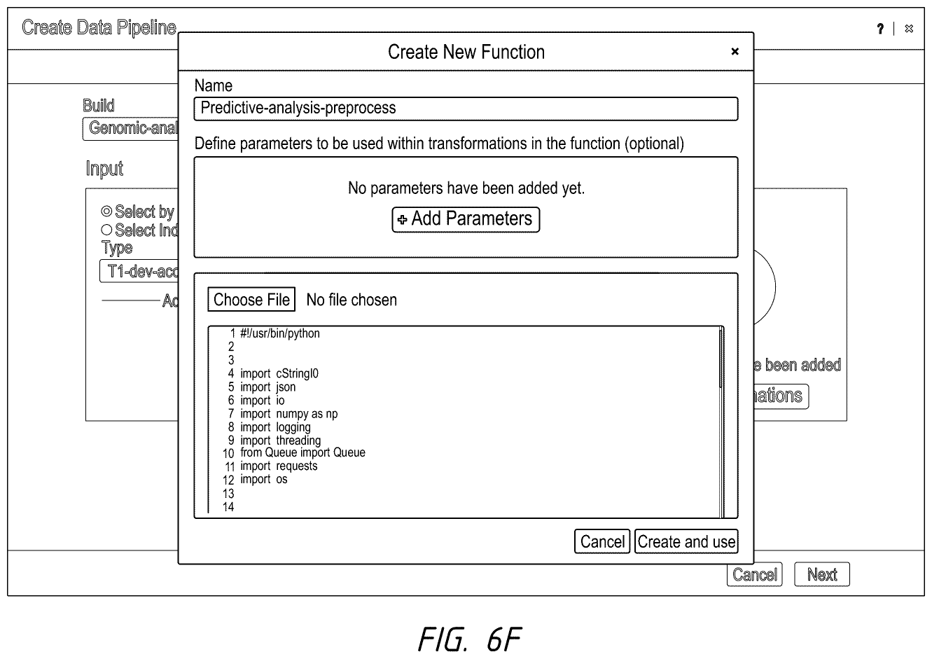

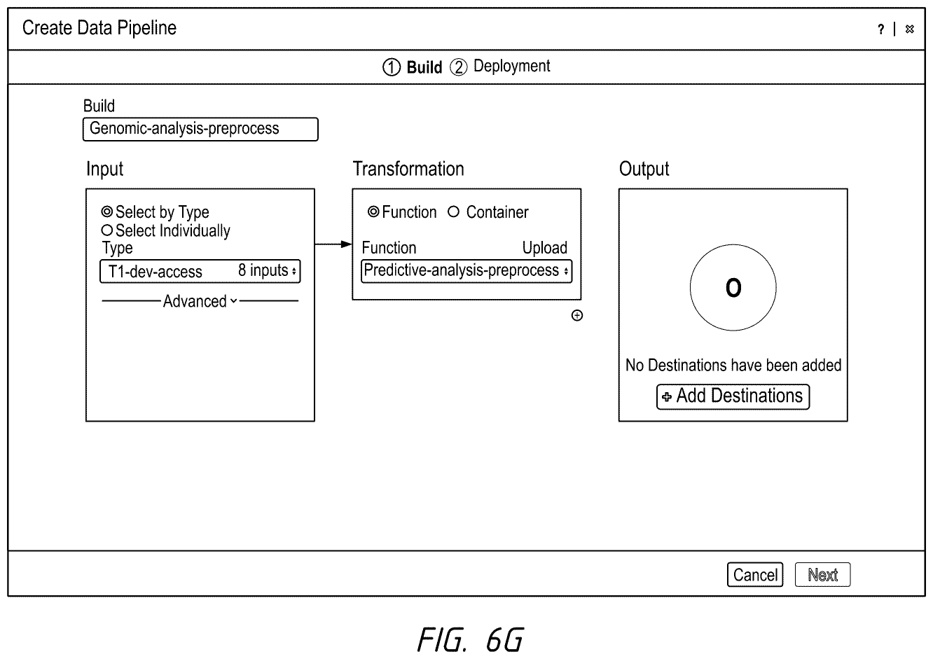

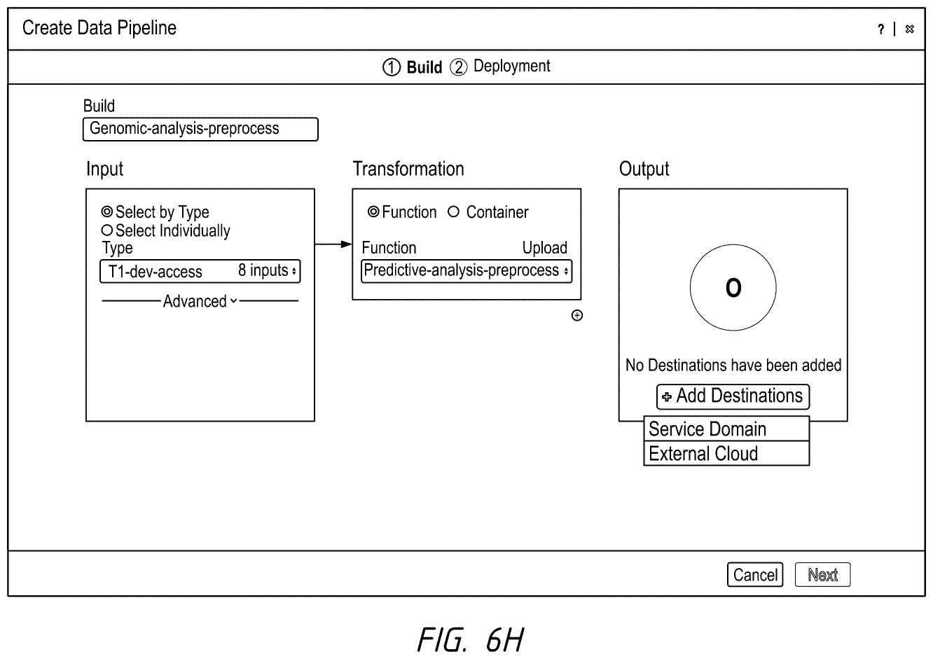

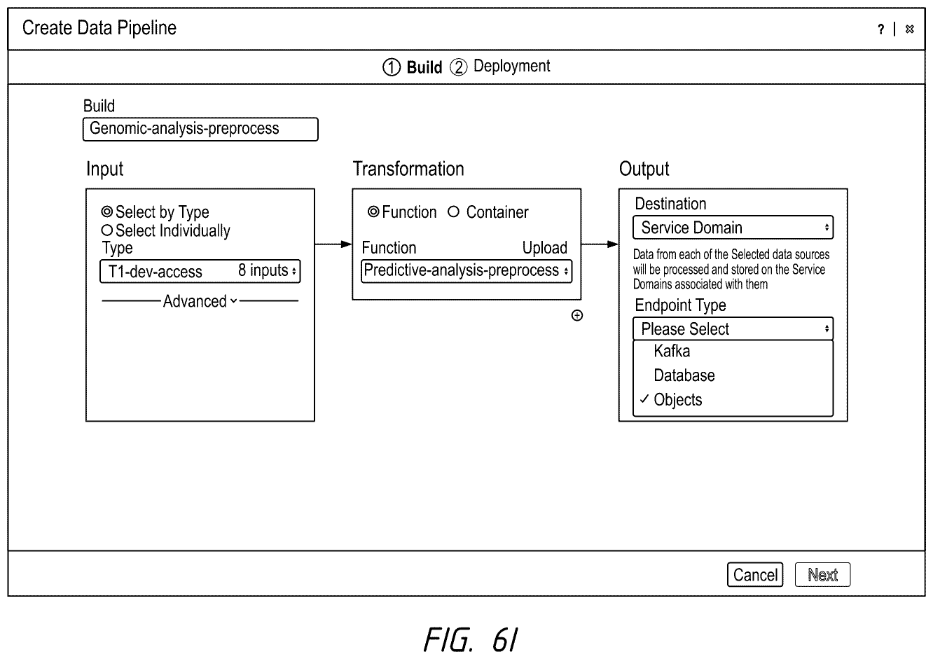

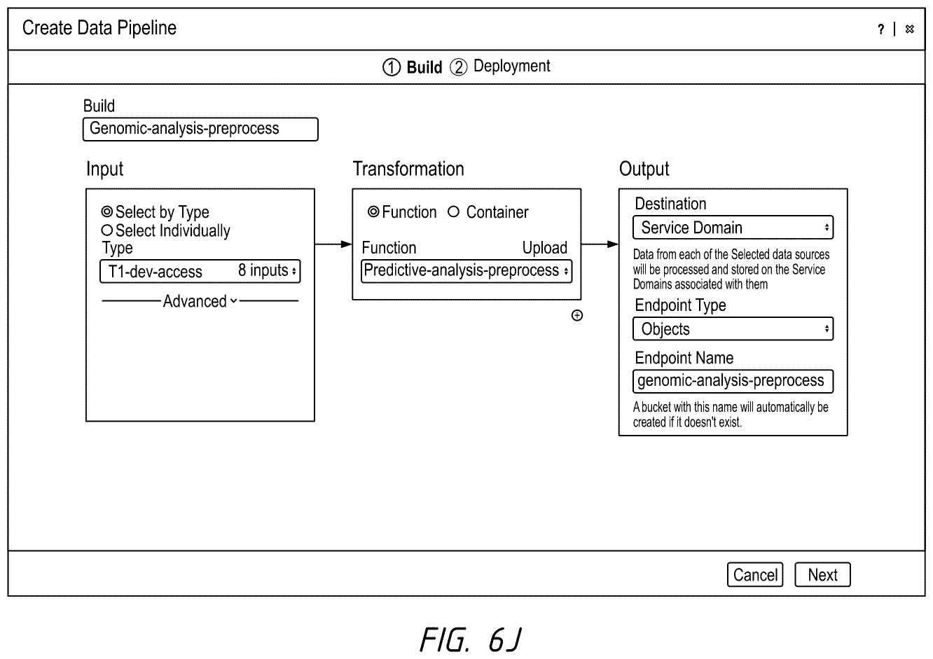

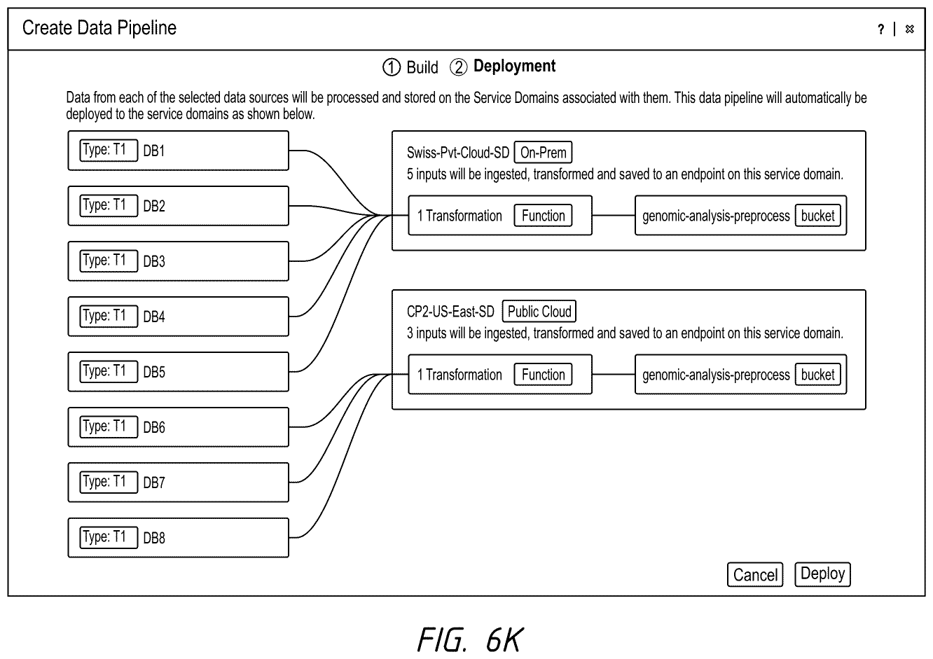

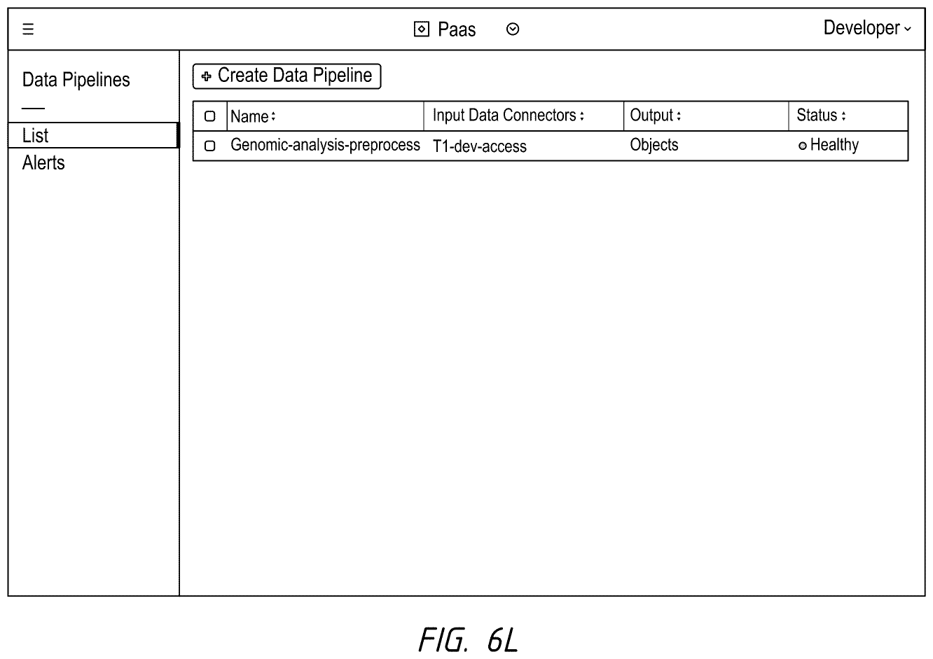

FIGS. 6A-6L are depictions of exemplary user interface screenshots for generating and deploying a data pipeline (e.g., one of the data pipeline(s) 115, 117, and/or 153) to one or more service domains, in accordance with an embodiment of the present disclosure. The interfaces depicted in FIGS. 6A-6L may be implemented in the GUI of the PaaS manager interface 104. FIG. 6A includes an interface in the GUI of the PaaS manager interface 104 to add an input (shown being performed in FIGS. 6B and 6C), transformation (shown being performed in FIGS. 6D-6G), or output (shown being performed in FIGS. 6H-6J). FIG. 6K depicts an interface for mapping of source data to a data pipeline, and FIG. 6L may provide a list of generated data pipelines.

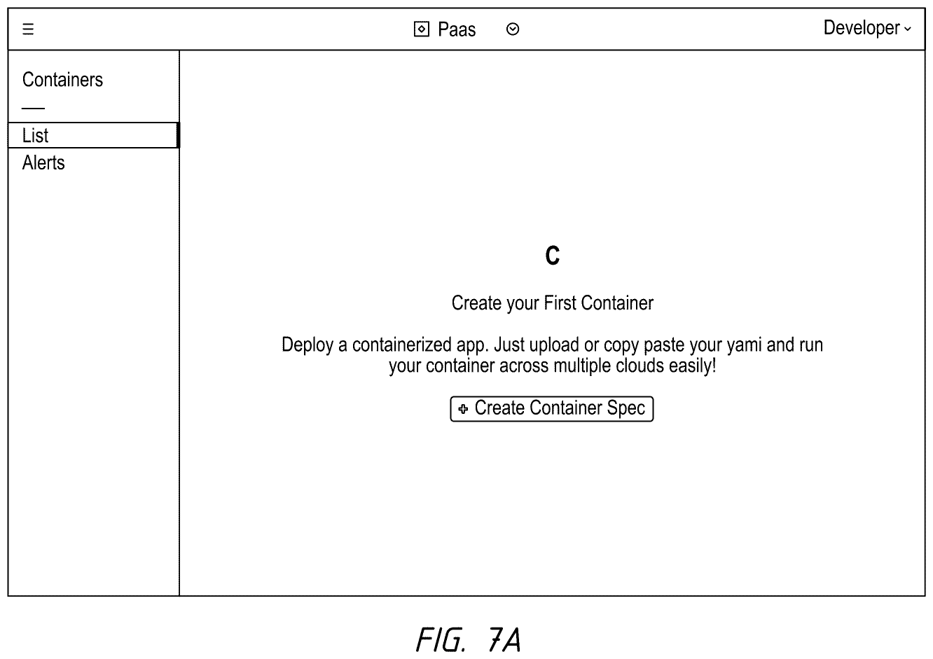

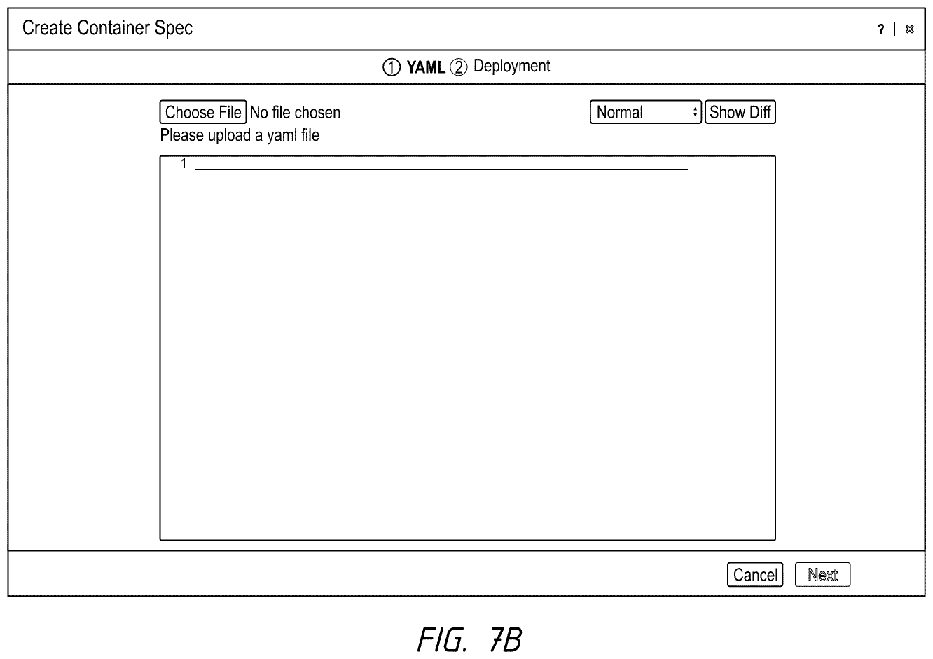

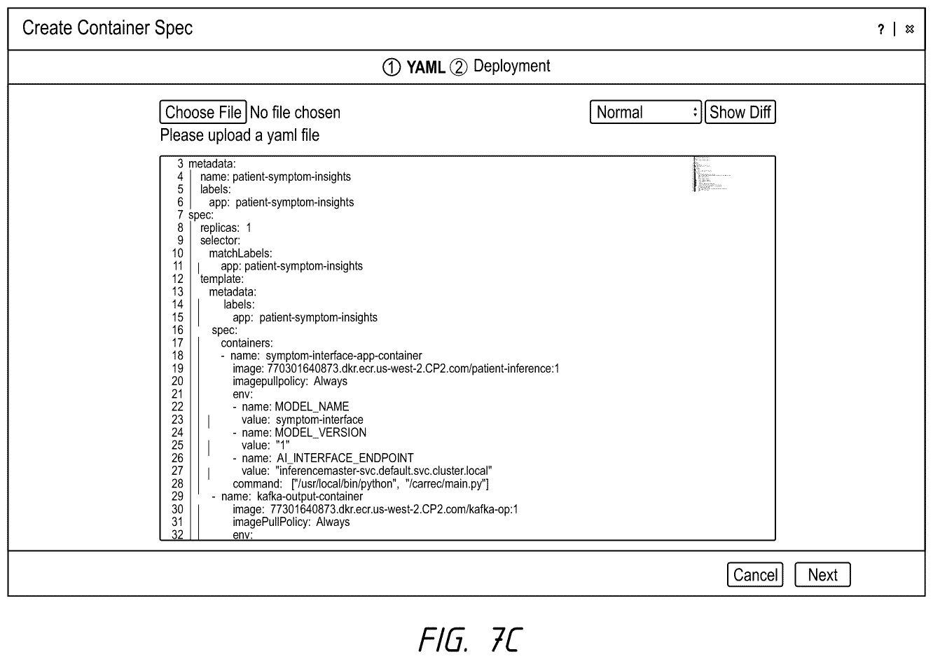

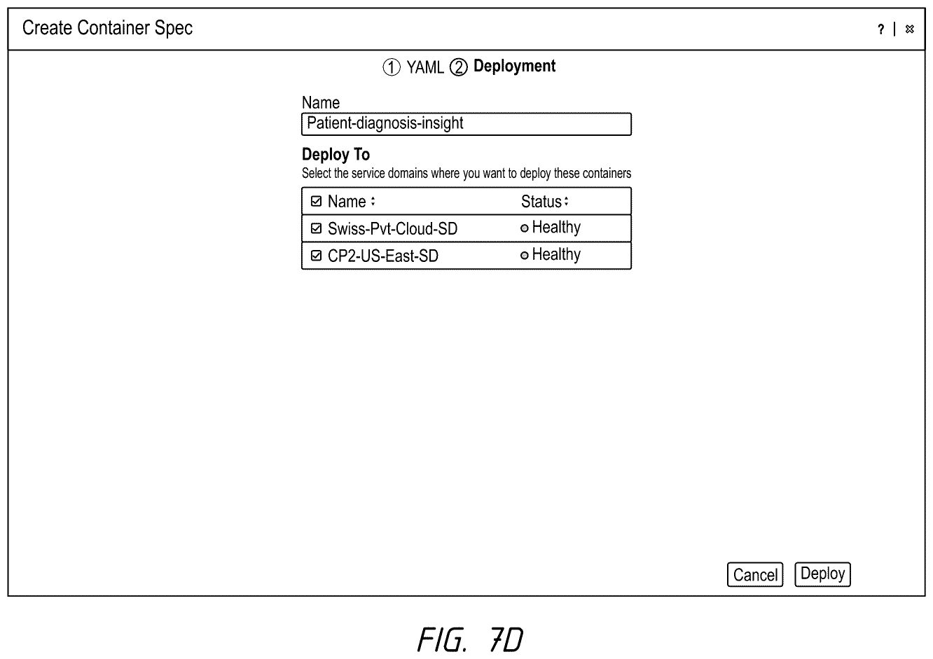

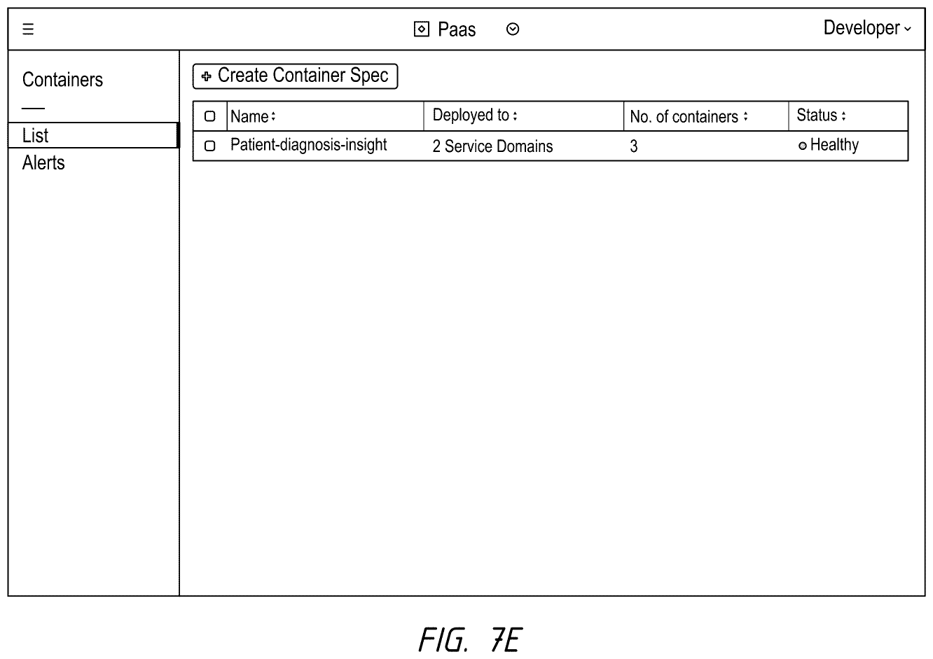

FIGS. 7A-7E are depictions of exemplary user interface screenshots for generating and deploying a container to one or more service domains, in accordance with an embodiment of the present disclosure. The interfaces depicted in FIGS. 7A-7E may be implemented in the GUI of the PaaS manager interface 104. FIGS. 7B and 7C depict interfaces for entering container code, FIG. 7D depicts an interface for selecting where the container is deployed, and FIG. 7E depicts an interface showing a list of deployed containers.

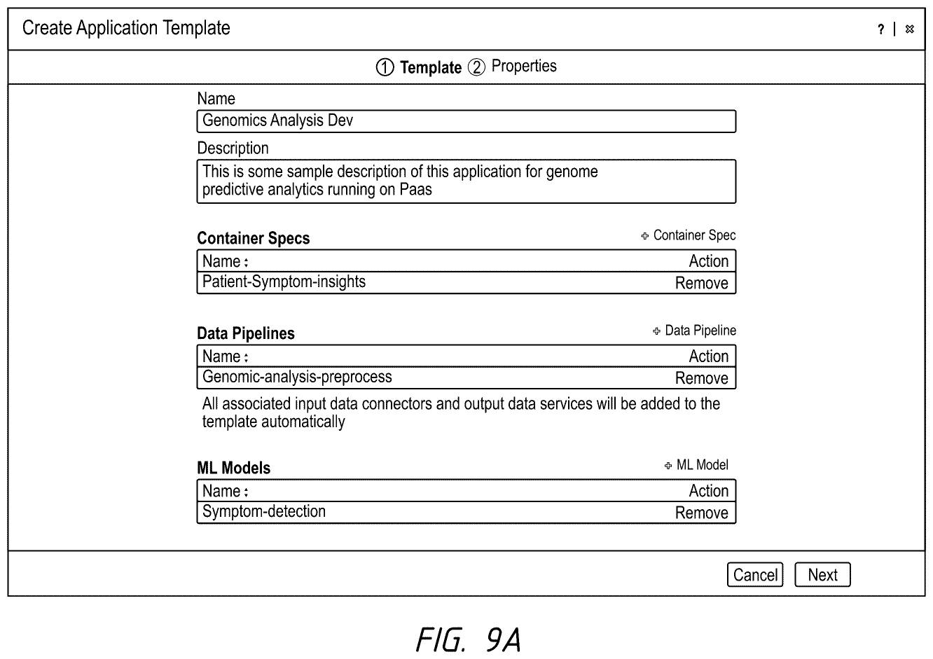

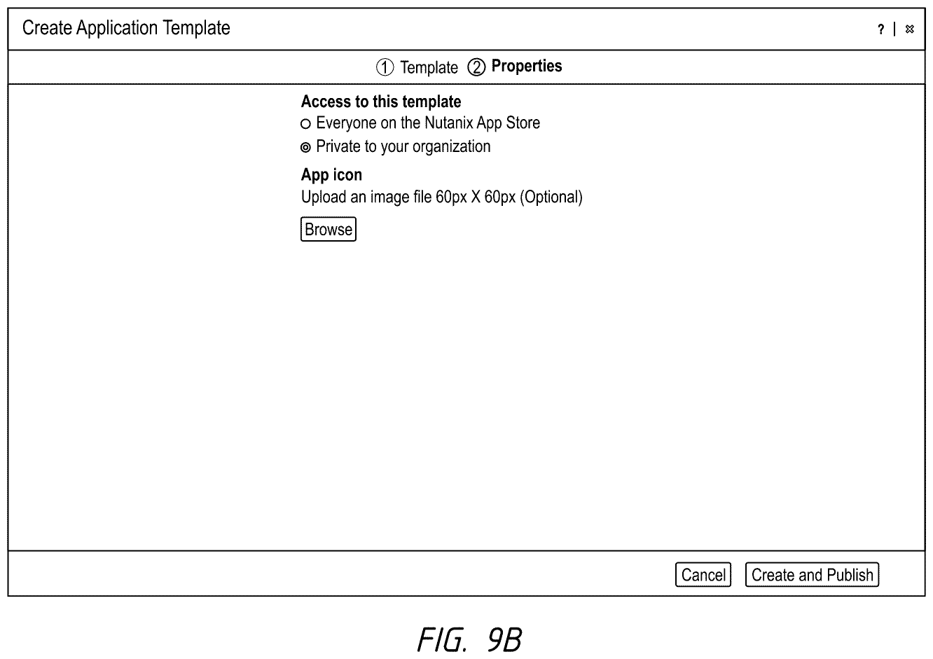

FIGS. 9A-9B are depictions of exemplary user interface screenshots for generating and deploying an application to one or more service domains, in accordance with an embodiment of the present disclosure. The interfaces depicted in FIGS. 9A-9B may be implemented in the GUI of the PaaS manager interface 104. FIG. 9A depicts an interface that allows a user to select the parts that make up an application template, and FIG. 9B depicts an interface that allows a user to select whether the application template is public or private.

The PaaS manager 142 may be configured to generate (e.g., build, construct, update, etc.) and distribute the applications to selected service domains based on the platform-specific architectures of the computing platforms. In some examples, the PaaS manager 142 may facilitate creation of one or more application constructs and may facilitate association of a respective one or more service domains with a particular application construct (e.g., in response to user input).

For example, in response to a request for deployment of a new application, the PaaS manager 142 may determine whether the new application is properly configured to run in a target service domain. The PaaS manager 142 may ensure that service dependencies for the new application are met in the service domains, in some examples, such as deployment of supporting services for the application to a target service domain.

In operation, the system 100 may include any number and combination of computing platforms that may collectively span any type of geographic area (e.g., across continents, countries, states, cities, counties, facilities, buildings, floors, rooms, systems, units, or any combination thereof). The computing platforms within the system 100 may include a wide array of hardware and software architectures and capabilities. Each of the computing platforms may host respective software stacks that include various applications that are configured to receive, process, and/or transmit/store data from one or more of the connected data sources 120 and/or from other applications. The service domain architecture may allow formation of a hybrid cloud computing platform where applications and data can be moved across different computing platforms.

Each of the applications may be configured to process data using respective algorithms or functions, and well as leveraging respective supporting services. In some examples, the algorithms or functions may include any other user-specified or defined function to process/transform/select/etc. received data. The supporting services may include runtime services, read/write data services, communication services, ML inference services, search services, etc., or any combination thereof. In some examples, the service domain for a respective computing platform may be configured to share data with other service domains. The one or more applications of the PaaS software stacks may be implemented using a containerized architecture that is managed via a container orchestrator. The applications may communicate using application programming interface (API) calls, in some examples.

The PaaS manager 142 may be configured to generate or update service domains to host the PaaS software stacks on the computing platforms. The service domains may include deployment of one or more virtual machines or other construct configured to host the respective PaaS software stack. The service domain may identify computing resource types and allocation.

The PaaS manager 142 may be further configured to deploy applications to the PaaS software stacks, as well as supporting services for execution of the application. A user may elect to deploy an application to a type of platform based on various criteria, such as type of service, proximity to source data, available computing resources (e.g., both type and available capacity), platform cost, etc., or any combination thereof. When an application is generated, successful execution may depend on availability of various additional supporting services, such as a read/write data services (e.g., publish/subscribe service, search services, etc.), ML inference services, container management services, runtime services, etc., or any combination thereof. The PaaS manager 142 may abstract deployment of the additional supporting services, as some of these may be platform-specific. Thus, a user may provide information directed to an application to be deployed to the PaaS manager 142 and identify one or more target service domains, and the PaaS manager 142 may deploy a respective application bundle to each of the one or more target service domains, along with a bundle of additional supporting services required for execution of the application bundle.

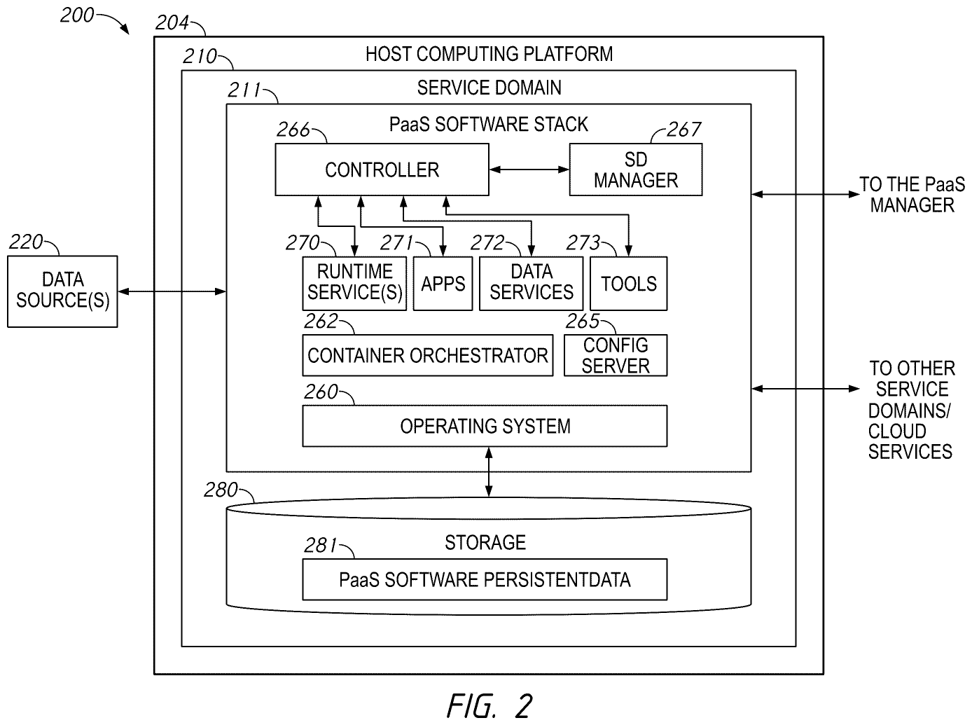

FIG. 2 is a block diagram of a computing system 200, in accordance with an embodiment of the present disclosure. The computing system 200 may include a host computing platform 204 configured to host a service domain 210. The service domain 210 may be configured to host a PaaS software stack 211 and storage 280. The host computing platform 204 may include any of a computing cluster platform, a bare metal system platform, a server, a public or private cloud computing platform, an edge system, or any other computing platform capable of hosting the 210. Any of the computing cluster service domain(s) 112, the bare metal system service domain(s) 114, and/or the cloud computing system service domain(s) 150 of FIG. 1 may implement a respective version of the service domain 210. Any of the PaaS software stack 113, the PaaS software stack 116, and/or PaaS software stack 152 of FIG. 1 may implement some or all of the PaaS software stack 211.

In some examples, the service domain 210 may be configured to host a respective PaaS software stack 211. In some examples, the service domain 210 may include a VM hosted on the host computing platform 204.

The storage 280 may be configured to store PaaS software persistent data 281, such as software images, binaries and libraries, metadata, etc., to be used by the service domain 210 to load and execute the PaaS software stack 211. In some examples, the PaaS software persistent data 281 includes instructions that when executed by a processor of the service domain 210, causes the PaaS software stack 211 to perform functions described herein. The storage may include local storage (solid state drives (SSDs), hard disk drives (HDDs), flash or other non-volatile memory, volatile memory, or any combination thereof), cloud storage, networked storage, or any combination thereof.

The PaaS software stack 211 includes a bundle hosted on a physical layer of the service domain 210 to facilitate communication with one or more data source(s) 220 (e.g., internal or external to the system 200), other service domains and/or computing platforms and/or a PaaS infrastructure and application lifecycle manager (e.g., the PaaS manager 142 of FIG. 1). The data source(s) 220 may include input/output devices (e.g., sensors (e.g., electrical, temperature, matter flow, movement, position, biometric data, or any other type of sensor), cameras, transducers, any type of RF receiver, or any other type of device configured to receive and/or generate source data), enterprise or custom databases, or any other source of data consumed, retrieved, stored, or generated by the service domains.

The PaaS software stack 211 may host an underlying operating system 260 configured to interface the physical layer of the service domain 210. In some examples, a controller 266, a service domain manager 267, a container orchestrator 262, and a configuration server 265 may run on the operating system 260. In some examples, the PaaS software stack 211 may include a bare metal implementation that runs the operating system 260 directly on the physical layer. In other examples, the PaaS software stack 211 may include a virtualized implementation with a hypervisor running on the physical layer and the operating system 260 running on the hypervisor.

The container orchestrator 262 may be configured to manage a containerized architecture of one or more of runtime services 270, applications 271, data services 272, and/or tools 273). In some examples, the container orchestrator 262 may include Kubernetes® container orchestration software. The runtime services 272 may include containers, functions, machine learning, AI inferencing, data pipelines, or any combination thereof. The data services may include publish/subscribe services, file system storage, databases, block storage, object storage, or any combination thereof. The tools 273 may include real-time monitoring tools, debugging tools, logging tools, alerting tools, or any combination thereof. The applications 271 may include any executable application configured to run in the PaaS software stack 211.

The service domain manager 267 may communicate with the PaaS manager to receive application bundles (e.g., including applications and supporting services) for installation (e.g., including the runtime services 270, the applications 271, the data services 272, and/or the tools 273), as well as data source connectivity information, etc. In some examples, the service domain manager 267 may also be configured to provide configuration and status information to a centralized PaaS manager, including status information associated with one or more of the data source(s) 220.

In response to information received from the PaaS manager, the service domain manager 267 may be configured to provide instructions to the controller 266 to manage the runtime services 270, the applications 271, the data services 272, and/or the tools 273 supported by the service domain 210, which may include causing installation or upgrading of one of the runtime services 270, the applications 271, the data services 272, and/or the tools 273; removing one of the runtime services 270, the applications 271, the data services 272, and/or the tools 273; starting or stopping new instances of the runtime services 270, the applications 271, the data services 272, and/or the tools 273; allocating service domains to host the PaaS software stack 211; or any combination thereof. The PaaS software persistent data 281 may include application data that includes data specific to the respective application to facilitate execution, including supporting services.

As previously described, the runtime services 270, the applications 271, the data services 272, and/or the tools 273 may be implemented using a containerized architecture to receive source data from one or more of the data source(s) 220 (e.g., or from applications) and to provide respective transformed data at an output by applying a respective function or algorithm to the received source data. In some examples, the applications may include any user-specified or defined function or algorithm.

In some examples, the runtime services 270 may include data pipelines (e.g., the data pipeline(s) 115, 117, and/or 153 of FIG. 1) that are constructed using a group of containers (e.g., a pod) that each perform various functions within the data pipeline runtime services 270, the applications 271, the data services 272, and/or the tools 273, such as subscriber, data processor, publisher, connectors that transform data for consumption by another container within the application or pod, etc.). In some examples, the definition of stages of a constructed data pipeline may be described using a user interface or REST API, with data ingestion and movement handled by connector components built into the data pipeline. Thus, data may be passed between containers of a data pipeline using API calls.

In some examples, the data pipelines may provide a conduit through which data can be passed (e.g., provided and/or received) between applications hosted in the PaaS Software stack, as well as a conduit through which data can be passed among different service domains or to other cloud services (e.g., via a network). Generally, a data pipelines may include an input component to receive data from another data pipeline, any data source, or other service domain or cloud service; an output component to provide data to another data pipeline, any data source, or other service domain or cloud service; and at least one transform component configured to manipulate the input data to provide the output data.

In operation, the PaaS software stack 211 hosted on the service domain 210 may control operation of the service domain 210 within an IoT system to facilitate communication with one or more data source(s) 220. The service domain manager 267 of the PaaS software stack 211 may communicate with the PaaS manager to receive allocation of a service domain to host the PaaS software stack 211 and receive application bundles for installation (e.g., including the runtime services 270, the applications 271, the data services 272, and/or the tools 273) on the PaaS software stack 211. In response to information received from the PaaS manager, the service domain manager 267 may be configured to provide instructions to the controller 266 to manage the application bundles, which may include causing installation or upgrading of one of the application bundles; removing one of the application bundles; starting or stopping new instances of the application bundles, allocating hardware resources to the PaaS software stack 211 as part of the service domain, storing data in and/or retrieving data from the PaaS software persistent data 281, or any combination thereof.

The runtime services 270, the applications 271, the data services 272, and/or the tools 273 may receive source data from one or more of the data source(s) 220 (e.g., or from other applications) and to provide respective transformed data at an output by applying a respective function or algorithm to the received source data. In some examples, the respective algorithms or functions may include machine learning (ML) or artificial intelligence (AI) algorithms. In some examples, the applications may cause the received and/or processed source data to be provided to other service domains via the configuration server 265. In some examples, the applications may be implemented using a containerized architecture deployed and managed by the container orchestrator 262. Thus, the container orchestrator 262 may deploy, start, stop, and manage communication with the runtime services 270, the applications 271, the data services 272, and/or the tools 273 within the PaaS software stack 211.

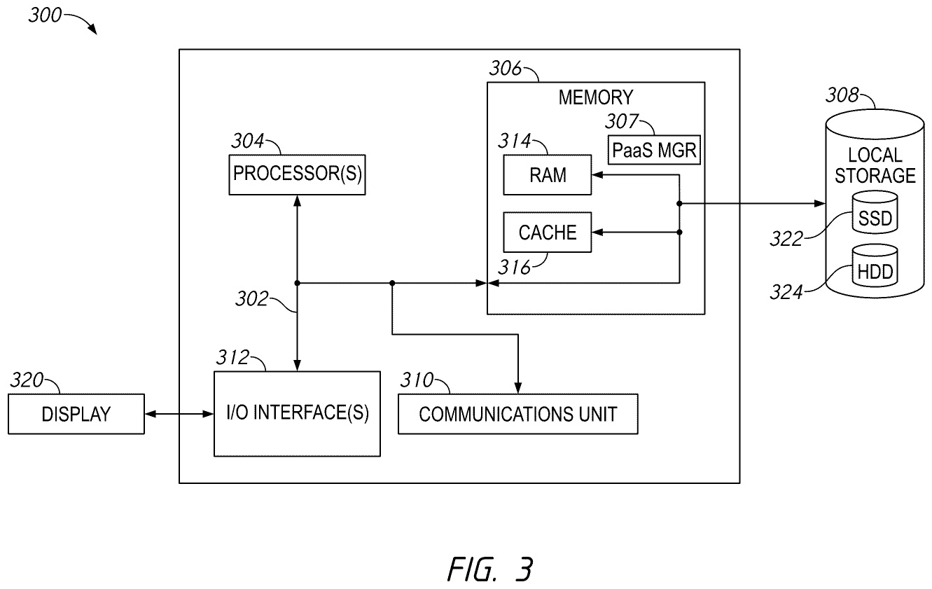

FIG. 3 depicts a block diagram of components of a computing node (device) 300 in accordance with an embodiment of the present disclosure. It should be appreciated that FIG. 3 provides only an illustration of one implementation and does not imply any limitations with regard to the environments in which different embodiments may be implemented. Many modifications to the depicted environment may be made. The computing node 300 may implemented as at least part of the central computing system 140 (or any other computing device or part of any other system described herein). In some examples, the computing node 300 may be a standalone computing node or part of a cluster of computing nodes configured to host a PaaS manager 307. In addition to or alternative to hosting the PaaS manager 307, the computing node 300 may be included as at least part of the computing cluster, the bare metal computing platform, or the cloud computing platform described with reference to FIG. 1 configured to host the described service domains.

The computing node 300 includes a communications fabric 302, which provides communications between one or more processor(s) 304, memory 306, local storage 308, communications unit 310, I/O interface(s) 312. The communications fabric 302 can be implemented with any architecture designed for passing data and/or control information between processors (such as microprocessors, communications and network processors, etc.), system memory, peripheral devices, and any other hardware components within a system. For example, the communications fabric 302 can be implemented with one or more buses.

The memory 306 and the local storage 308 are computer-readable storage media. In this embodiment, the memory 306 includes random access memory RAM 314 and cache 316. In general, the memory 306 can include any suitable volatile or non-volatile computer-readable storage media. In an embodiment, the local storage 308 includes an SSD 322 and an HDD 324.

Various computer instructions, programs, files, images, etc. may be stored in local storage 308 for execution by one or more of the respective processor(s) 304 via one or more memories of memory 306. In some examples, local storage 308 includes a magnetic HDD 324. Alternatively, or in addition to a magnetic hard disk drive, local storage 308 can include the SSD 322, a semiconductor storage device, a read-only memory (ROM), an erasable programmable read-only memory (EPROM), a flash memory, or any other computer-readable storage media that is capable of storing program instructions or digital information.

The media used by local storage 308 may also be removable. For example, a removable hard drive may be used for local storage 308. Other examples include optical and magnetic disks, thumb drives, and smart cards that are inserted into a drive for transfer onto another computer-readable storage medium that is also part of local storage 308.

In some examples, the local storage may be configured to store a PaaS manager 307 that is configured to, when executed by the processor(s) 304, create and deploy service domains on one or more different types of computing platforms. The PaaS manager 307 may also be configured to, when executed by the processor(s) 304, deploy different types of applications to the service domains. An application may include a data pipeline, a container, a data service, a machine learning (ML) model, etc., or any combination thereof. A user may elect to deploy an application to a type of platform based on various criteria, such as type of service, proximity to source data, available computing resources (e.g., both type and available capacity), platform cost, etc., or any combination thereof. Types of platforms may include a cloud platform (e.g., Nutanix, Amazon® Web Services (AWS®), Google® Cloud Platform, Microsoft® Azure®, etc.), a computing node cluster, a bare metal platform, an IoT platform (e.g., edge systems, etc.). When an application is generated, successful execution may depend on availability of various additional supporting services, such as a read/write data services (e.g., publish/subscribe service, search services, etc.), ML inference services, container management services, runtime services, etc., or any combination thereof. The PaaS manager 307 may abstract deployment of the additional supporting services, as some of these may be platform-specific. Thus, a user may provide information directed to an application to be deployed to the PaaS manager 307 and identify one or more target service domains, and the PaaS manager 307 may generate a respective application bundle for each of the one or more target service domains that includes the application and the additional supporting services. The PaaS manager 307 may deploy the respective application bundle to the corresponding one of the one or more identified target service domains. The ability of the PaaS manager 307 to abstract platform-specific details for creating and deploying a service domain and creating an application bundle to run in a service domain may make deployment of applications to different service domains more efficient for a user.

Communications unit 310, in these examples, provides for communications with other data processing systems or devices. In these examples, communications unit 310 includes one or more network interface cards. Communications unit 310 may provide communications through the use of either or both physical and wireless communications links.

I/O interface(s) 312 allows for input and output of data with other devices that may be connected to computing node 300. For example, I/O interface(s) 312 may provide a connection to external device(s) 318 such as a keyboard, a keypad, a touch screen, and/or some other suitable input device. External device(s) 318 can also include portable computer-readable storage media such as, for example, thumb drives, portable optical or magnetic disks, and memory cards. Software and data used to practice embodiments of the present disclosure can be stored on such portable computer-readable storage media and can be loaded onto local storage 308 via I/O interface(s) 312. I/O interface(s) 312 also connect to a display 320.

Display 320 provides a mechanism to display data to a user and may be, for example, a computer monitor. In some examples, a GUI associated with the PaaS manager interface 104 of FIG. 1 may be presented on the display 320.

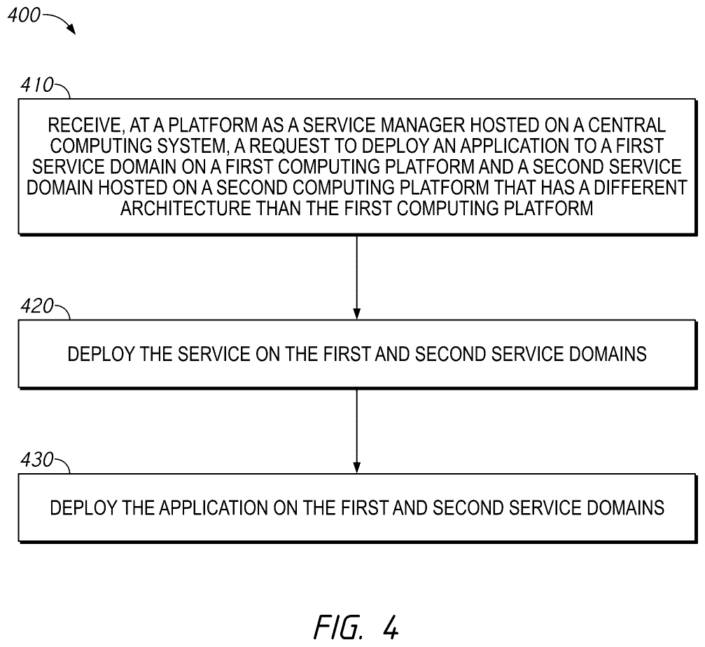

FIG. 4 is a flow diagram of a method 400 to create an application for deployment to a computing platform, in accordance with an embodiment of the present disclosure. The method 400 may be performed by the PaaS manager 142 of FIG. 1 and/or the PaaS manager 307 of FIG. 3.

The method 400 may include receiving, at a platform as a service manager hosted on a central computing system, a request to deploy an application to a first service domain on a first computing platform and a second service domain hosted on a second computing platform that has a different architecture than the first computing platform, at 410. The application utilizes an abstraction of a service. The first and second computing platforms may include any of the computing platforms of FIG. 1 configured to host computing cluster service domain(s) 112, the bare metal system service domain(s) 114, and or the cloud computing system service domain(s) 150, and/or the host computing platform 204 of FIG. 2. In some examples, the application includes at least one of a containerized application, a data pipeline, a machine learning model, or a data service. In some examples, the method 400 may further include providing a list of service domains available for deployment of the application, including the first and second service domains.

In some examples, the method 400 may further include, deploying each of the first service domain and the second service domain to a respective cloud computing platform, a computing node cluster platform, a bare metal platform, or an edge platform. In some examples, the method 400 may further include deploying a third service domain to a third computing platform having an architecture different than the first and second computing platforms in response to receipt of a request to generate the third service domain. In some examples, the first and second service domains each include a respective at least one virtual machine hosted on the first and second computing platforms, respectively. In some examples, the method 400 may further include providing a platform as a service software stack to the first and/or second computing platforms to deploy the first and/or second service domains, respectively.

The method 400 may further include deploying the service on the first and second service domains, at 420. In some examples, the method 400 may further include deploying at least one of a runtime service, a data service, or tool to the first and second service domains. The method 400 may further include deploying the application on the first and second service domains, at 430. In some examples, the method 400 may further include training a machine learning model for inclusion in the application based on data received from an external data source.

The method 400 may be implemented as instructions stored on a computer readable medium (e.g., memory, disks, etc.) that are executable by one or more processor units (e.g., central processor units (CPUs), graphic processor units (GPUs), tensor processing units (TPUs), hardware accelerators, video processing units (VPUs), etc.) to perform the method 400.

Various features described herein may be implemented in hardware, software executed by a processor, firmware, or any combination thereof. If implemented in software (e.g., in the case of the methods described herein), the functions may be stored on or transmitted over as one or more instructions or code on a computer-readable medium. Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), or optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor.

From the foregoing it will be appreciated that, although specific embodiments of the disclosure have been described herein for purposes of illustration, various modifications may be made without deviating from the spirit and scope of the disclosure. Accordingly, the disclosure is not limited except as by the appended claims.

What is claimed is:

1. At least one non-transitory computer-readable storage medium including instructions that, when executed by a computing node, cause the computing node to:
receive a request to deploy an application to a first service domain on a first computing platform and a second service domain hosted on a second computing platform having a different architecture than the first computing platform, wherein the application utilizes an abstraction of a service; and
deploy the service on the first and second service domains; and
deploy the application on the first and second service domains.
